(19) United States
(12) Patent Application Publication
(10) Pub. No.: US 2025/0020150 A1
(43) Pub. Date: Jan. 16, 2025

(54) DECKING SYSTEM, PLUG APPARATUS THEREOF, AND RELATED METHODS

(71) Applicant: Trex Company, Inc, Winchester, VA (US)

(72) Inventors: Darren W. Garrison, Capon Bridge, WV (US); Jacob C. Hurst, Winchester, VA (US); Luis Rodrigo Piñeiro, Winchester, VA (US)

(21) Appl. No.: 18/769,860

(22) Filed: Jul. 11, 2024

Related U.S. Application Data
(60) Provisional application No. 63/513,198, filed on Jul. 12, 2023.

(51) Int. Cl. F16B 13/00

(52) U.S. Cl. CPC F16B 13/005

(57) ABSTRACT

A decking system including a plank and a plug that is configured for insertion into fastener holes of the plank to conceal the fastener holes. The plug may be formed as part of a plug apparatus which may be an injection molded monolithic structure including a support member and a plurality of the plugs coupled thereto. The support member may be a support strip that extends along a strip axis. The plurality of plugs may be connected to the support strip. Each of the plugs may be configured to be detached from the support strip and inserted into a fastener hole in a plank. The plugs may include a first set of the plugs located on a first lateral side of the support strip and a second set of the plugs located on a second lateral side of the support strip opposite the first lateral side.

A deck is an architectural structure that is typically elevated above the surrounding ground level to extend living space to the outdoors and/or provide users with a space on which to relax, cat, and perform other activities. Decking can be made from many materials, including wood and man-made or composite materials. Decking made from man-made or composite materials tends to have a very clean and consistent aesthetic, even if it includes a textured exterior. During assembly holes are formed through the decking planks to facilitate attachment to the underlying support structure. Currently, such holes are filled with plugs formed from one or more of the decking planks, with the rest of that decking plank being discarded as waste. A need exists for a plug apparatus, system, and method to conceal the holes and maintain the consistent aesthetic of the decking planks while reducing material waste and cost.

### SUMMARY

In one aspect, the invention may be a plug apparatus for concealing fastener holes formed in planks, the plug apparatus comprising: a support strip extending along a strip axis; and a plurality of plugs connected to the support strip, each of the plugs configured to be inserted into a fastener hole in a plank, the plugs comprising: a first set of the plugs located on a first lateral side of the support strip; and a second set of the plugs located on a second lateral side of the support strip opposite the first lateral side.

In another aspect, the invention may be a plug apparatus for concealing fastener holes formed in planks, the plug apparatus comprising: a support member; and a plurality of plugs connected to the support member, each of the plurality of the plugs configured to be inserted into a fastener hole in a plank; and wherein, for each of the plugs, a connection between the support member and the plug is configured to break to release the plug from the support member upon the plug being inserted into the fastener hole.

In yet another aspect, the invention may be a plug for concealing fastener holes formed in planks, the plug being an injection-molded monolithic body configured to be inserted into a fastener hole in a plank.

In still another aspect, the invention may be a decking system comprising: a plank comprising an upper surface formed of a composition comprising a first polymeric base material, the plank fastened to support structure by at least one fastener that results in a fastener hole in the upper surface of the plank; and an injection-molded monolithic body in the form of a plug configured to be inserted into and conceal the fastener hole in the plank, the injection-molded monolithic body formed of a composition comprising a second polymeric base material.

In a further aspect, the invention may be a method of installing a decking system, the method comprising: (a) aligning a first plug with a first fastener hole formed in one or more planks, the first plug being one of a plurality of plugs connected to a support member; and (b) inserting the first plug into the first fastener hole, the first plug breaking off of and being released from the support member.

In a still further aspect, the invention may be a method of manufacturing plugs for concealing fastener holes, the method comprising: (a) forming a mold cavity comprising at least one plug chamber with a mold, an insert positioned within the at least one plug chamber so that a textured side of the insert forms a roof of the at least one plug chamber; (b) injecting a hot fluidic composition into the mold cavity to fill the mold cavity; (c) allowing the fluidic composition to cool; and (d) removing a formed plug from the at least one plug chamber, the formed plug having a top surface comprising a texture pattern corresponding to a texture pattern of the textured side of the insert.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The features of the exemplary embodiments of the present invention will be described with reference to the following drawings, where like elements are labeled similarly, and in which:

FIG. 1 is perspective view of a decking system in accordance with an embodiment of the present invention;

FIG. 2 is a close-up view of area II of FIG. 1;

FIG. 3 is an exploded view of a portion of a decking system in accordance with an embodiment of the present invention;

FIG. 4 is a perspective view of a plug apparatus in accordance with an embodiment of the present invention;

FIG. 5 is a top plan view of the plug apparatus of FIG. 4;

FIG. 6 is a cross-sectional view taken along line VI-VI of FIG. 5;

FIG. 7 is a perspective view of a plug of the plug apparatus of FIG. 4;

FIG. 8 is a front view of the plug of FIG. 7;

FIG. 9A is a perspective view illustrating a fastener being used to fasten a decking plank to a support structure in accordance with an embodiment of the present invention;

FIG. 9B is a perspective view illustrating a plug of a plug apparatus being aligned with and driven into a fastener hole formed into the decking plank by the fastener;

FIG. 9C is a cross-sectional view taken along line IXC-IXC of FIG. 9B;

FIG. 9D is a perspective view illustrating the fastener hole filled with the plug and with the plug apparatus being moved away from the decking plank;

FIG. 10 is a cross-sectional view taken along line X-X of FIG. 9C;

FIG. 11 is a close-up view of area XI of FIG. 10;

FIG. 12 is a cross-sectional view of a mold having a mold cavity for manufacturing a plug or a plug apparatus in accordance with an embodiment of the present invention;

FIG. 13 is a perspective view of an insert that is positioned within a plug chamber of the mold cavity of the mold of FIG. 12 during the manufacture of the plug or the plug apparatus;

FIG. 14A is a cross-sectional view of the mold of FIG. 12 in an open position;

FIG. 14B is the cross-sectional view of the mold of FIG. 14A with the insert of FIG. 13 positioned within the plug chamber;

FIG. 14C is the cross-sectional view of the mold of FIG. 14B, in a closed position;

FIG. 14D is the cross-sectional view of the mold of FIG. 14C, illustrating the injection of a composition into the mold cavity;

FIG. 14E is the cross-sectional view of the mold of FIG. 14D illustrating the formed plug or plug apparatus within the mold cavity;

FIG. 15A is a perspective view of a plug made in the mold of FIG. 14A;

FIG. 15B is a perspective view of a plug apparatus made in the mold of FIG. 14A; and

FIG. 16 is a close-up view a portion of the decking system of FIG. 1 in accordance with an embodiment of the present invention.

Parts given a reference numerical designation in one figure may be considered to be the same parts where they appear in other figures without a numerical designation unless specifically labeled with a different part number and described herein.

### DETAILED DESCRIPTION

The features and benefits of the invention are illustrated and described herein by reference to exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range.

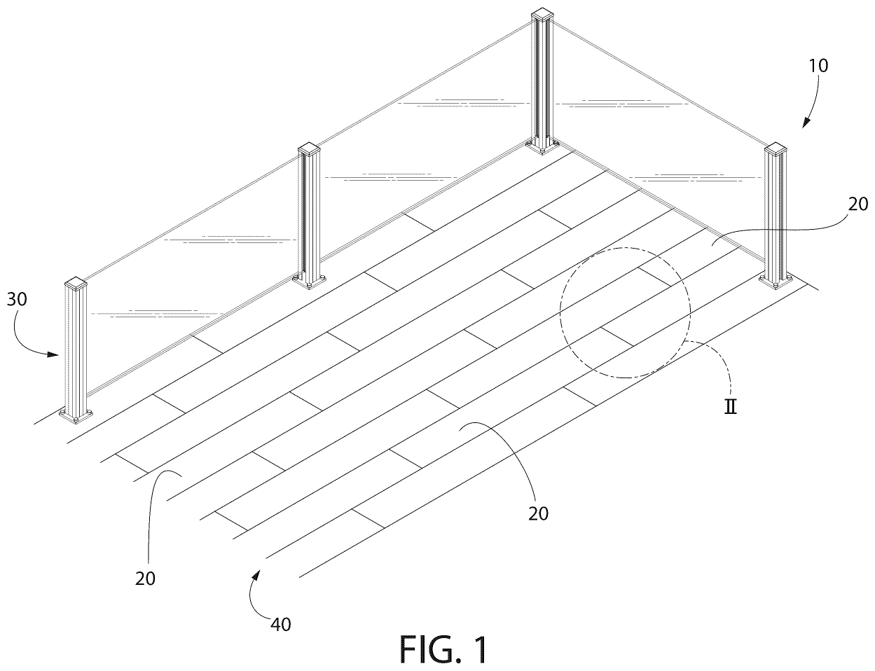

Referring first to FIG. 1, a decking system 10 is illustrated in accordance with an embodiment of the present invention. The decking system 10 comprises a plurality of planks or decking planks 20 that are arranged in a desired pattern and then fastened to one or more supports or support structures located below the planks 20. The planks 20 collectively form a deck or deck surface 40 upon which furniture may be placed and users may stand. In FIG. 1 the planks 20 are arranged in a staggered horizontal pattern. However, other patterns may be used including diagonal patterns, vertical patterns, patchwork patterns, herringbone patterns, or the like. In the exemplified embodiment, a railing system 30 is positioned along the perimeter of the deck 40 formed by the planks 20. The railing system 30 may comprise glass panels extending between posts as shown, or may include other infill materials such as cables, balusters, slats, privacy panels, or the like. The specific details about the railing system 30 may be modified considerably from that which is shown and the railing system 30 of the decking system 10 is not to be limited by the embodiment shown.

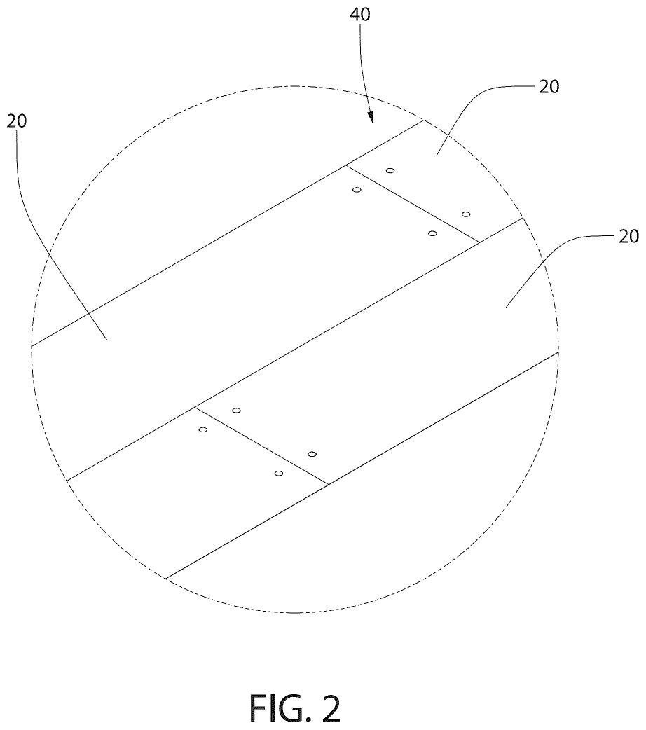

FIG. 2 is a close-up view of a portion of the deck 40 which includes portions of several of the planks 20. The planks 20 may be rectangular as shown or may take on other shapes, including square, triangular, hexagonal, other polygonal or non-polygonal shapes, irregular shapes, or the like. In FIG. 2, there are two circular features illustrated adjacent to the short edges of each of the planks 20. The two circular features represent regions where fasteners may be used to fasten the planks 20 to the underlying support structures. The fasteners may comprise screws, nails, bolts, staples, or other hardware or other styles of fasteners, the details of which will be provided below. When the fasteners are attached to the planks 20, the fasteners may be recessed relative to the deck surface 40, thereby leaving a hole in the planks 20. As described further herein, a plug may be fitted within the hole to create a seamless appearance along the deck surface 40. While a circular feature is depicted in FIG. 2 to be representative of the plug, the plug may have an aesthetic appearance which matches the aesthetic appearance of the planks 20 to create a seamless transition between the planks 20 and the plugs. This will be described in greater detail below.

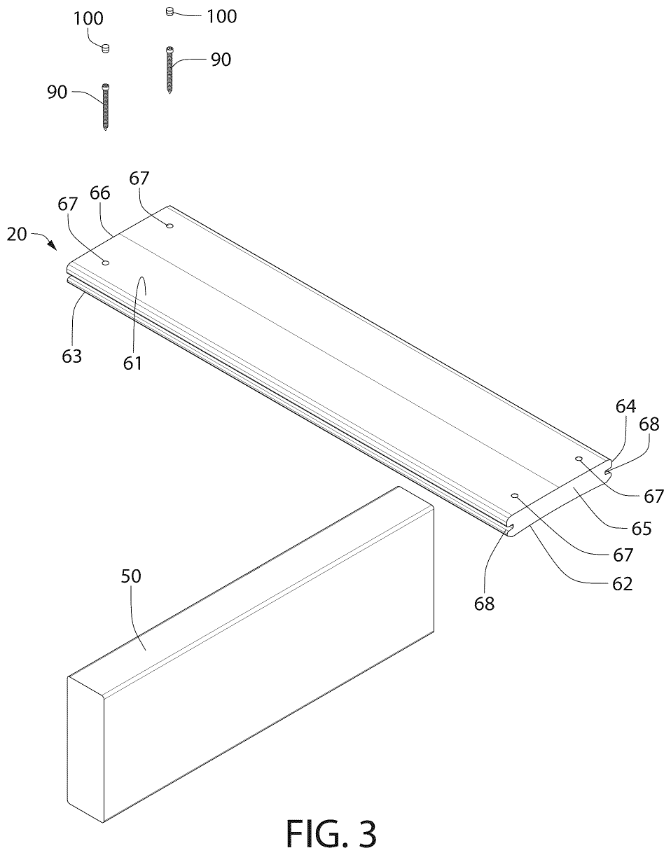

Referring to FIG. 3, an exploded view is provided which illustrates a plank 20, a support structure 50 to which the plank 20 is attached, a pair of fasteners 90, and a pair of plugs 100.

The support structure 50 may be formed from wood, although other materials may also be used including composite materials, engineered wood products, various hard plastics, or the like. A plurality of the support structures 50 may form beams, bridging, and joists that may collectively support the frame of the deck such as the planks 20. The planks 20 may be fastened directly to one or more of the support structures 50 in some embodiments. The fasteners 90 and the plugs 100 may be used to attach the planks 20 to the underlying support structure 50. While not illustrated, the pair of fasteners 90 and the pair of plugs 100 may be duplicated so that a second set of fasteners 90 and plugs 100 may be used to secure the opposite side of the plank 20 to the underlying support structure (which may be a distinct beam from the one which is shown). Additional fasteners and plugs may be included as needed depending on the overall shape and size of each plank 20.

A single plank 20 is illustrated in FIG. 3, although it may be representative of each of the planks 20 used in the decking system 10. The planks 20 of the decking system 10 need not all have the same shape and varying shaped planks 20 may be used within a singular decking system 10. The planks 20 may comprise a core and a cap or shell, with the cap or shell being co-extruded onto the top surface of the core during the extrusion process. Thus, the core and the cap/shell form a combined structure and they may not be separate parts.

The planks 20 may comprise a top surface 61, a bottom surface 62, a first side surface 63, and a second side surface 64. The planks 20 may comprise rounded corners between the top surface 61 and each of the first and second side surfaces 63, 64 and between the bottom surface 62 and each of the first and second side surfaces 63, 64. The planks 20 may comprise a first end 65 and a second end 66, with the planks 20 being elongated in a direction between the first and second ends 65, 66. The planks 20 may comprise pre-formed holes 67 that extend from the top surface 61 to the bottom surface 62 adjacent to each of the first and second ends 65, 66. Specifically, the planks 20 may comprise two or more pre-formed holes 67 adjacent to the first end 65 and two or more pre-formed holes 67 adjacent to the second end 66. In other embodiments, there may be no pre-formed holes and instead holes may be formed by the act of driving the fasteners 90 into and through the planks 20 as described below.

Each of the first and second side surfaces 63, 64 of the planks 20 may comprise grooves 68 that extend from the first end 65 to the second end 66. Thus, the grooves 68 may be elongated in the direction between the first and second ends 65, 66. In some embodiments, the planks 20 may be a solid and non-hollow structure.

The core of the planks 20 may be formed from a composite composition comprising a polymeric material and a cellulosic material. In an embodiment, the cellulosic material may be wood. In an embodiment, the polymeric material may be polyethylene. However, other polymeric materials may be used in other embodiments, including other synthetic polymers. In an embodiment, the core may comprise between 50% and 70%, or more specifically 55% and 65%, or more specifically approximately 60% wood. In an embodiment, the core may comprise between 30% and 50%, or more specifically between 35% and 45%, or more specifically approximately 40% polyethylene. In an embodiment, the core may comprise approximately 60% wood and approximately 60% polyethylene, with the term “approximately” intending to include a tolerance of plus or minus 5%.

As noted above, the planks 20 may comprise a cap or shell layer that is co-extruded onto the top surface of the core during the extrusion process to form a single structure for the plank 20. The shell may have a thickness between 0.5 mm and 5 mm, or between 0.5 mm and 3 mm in some embodiments. The shell may be formed from a polymeric material with additives for ultraviolet protection and scratch and/or mar performance. The polymeric material may be high density polyethylene in one embodiment, although other synthetic polymers may be used in other embodiments. In some embodiments, the shell may be omitted. In some embodiments, the top surface of the shell may comprise a texture feature. The texture feature may comprise a debossed or embossed texture pattern on the top surface of the shell. The texture feature may comprise a debossed or embossed wood grain pattern.

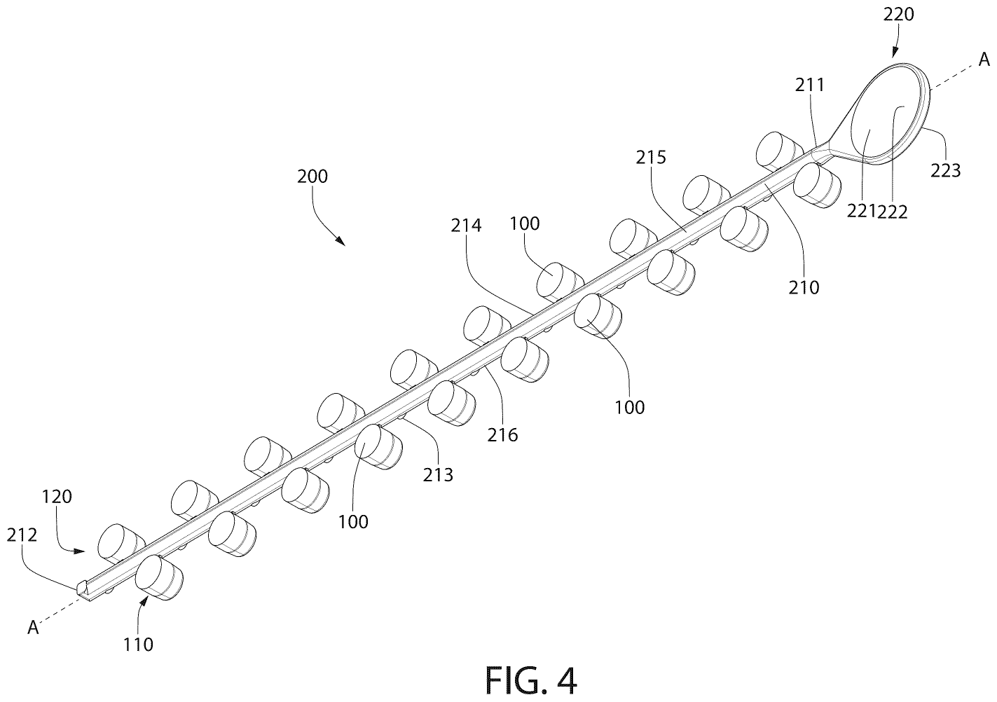

In the exemplified embodiment, the fasteners 90 that are used to couple the planks 20 to the support structure 50 comprise screws. However, the fasteners 90 could be other types of hardware, including bolts, nails, rivets, rods, or the like. When the fasteners 90 are used to couple the planks 20 to the support structure 50, a fastener hole may remain between the top end of the fastener 90 and the outer surface of the plank 20. This may be because the fasteners 90 may be recessed relative to the top surface 61 of the plank 20 when the fastener 90 is fully inserted into the plank 20 and the support structure 50. One of the plugs 100 may be positioned within each of the fastener holes to fill the hole and facilitate a seamless appearance for the deck system 10. The details of the plugs 100 will be provided below with reference to FIGS. 4-8.

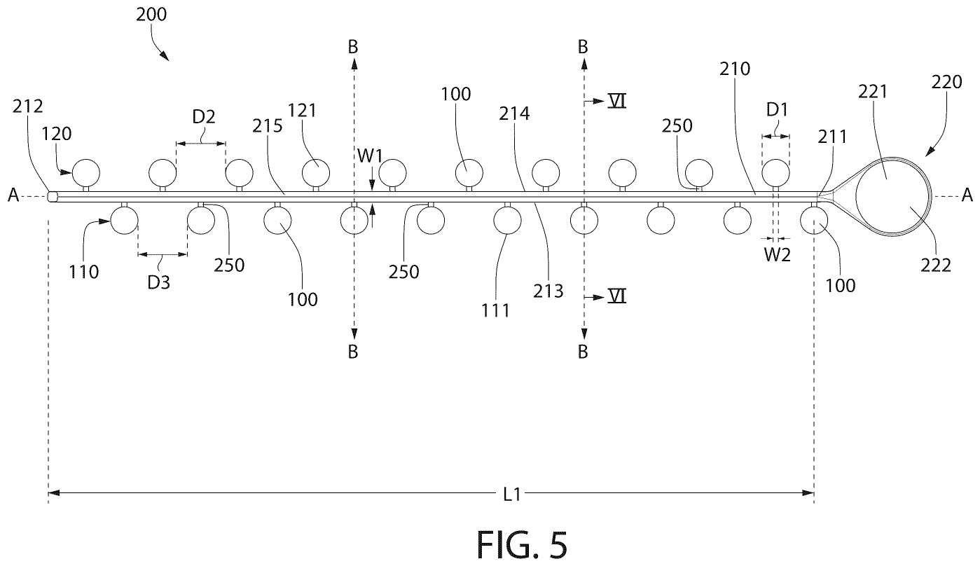

Referring to FIGS. 4 and 5, a plug apparatus 200 is illustrated in accordance with an embodiment of the present invention. The plug apparatus 200 may be used to conceal fastener holes formed into planks, such as the holes that are formed into the planks 20 when the fasteners 90 are used to couple the planks 20 to a support structure 50. The plug apparatus 200 generally comprises a support strip 210 and a plurality of the plugs 100 that are connected to the support strip 210. In an embodiment, each of the plurality of plugs 100 may be connected to the support strip 210 by an arm 250. The plugs 100 may be configured to be inserted into the fastener holes in the planks 20 as described herein.

The support strip 210 may extend along a strip axis A-A from a proximal end 211 of the support strip 210 to a distal end 212 of the support strip 210. The support strip 210 may comprise a first lateral side 213 and a second lateral side 214 opposite the first lateral side 213. The support strip 210 may comprise a top surface or a top-most surface 215 and a bottom surface or a bottom-most surface 216 that is opposite the top surface 615. The support strip 210 may be a thin strip that is elongated along the strip axis A-A and having a length L1 measured between the proximal end distal ends 211, 212 and a width W1 measured in a direction perpendicular to the strip axis A-A between the first and second lateral sides 213, 214. A ratio of the length L1 to the width W1 may be between 20:1 and 100:1, or between 40:1 and 100:1, or between 60:1 and 80:1, in various different embodiments. The specific dimensions for the length L1 and/or the width W1 may be modified in accordance with its specific intended use and purpose.

While the support strip 210 is exemplified as an elongated strip, the invention is not to be so limited in all embodiments. In other embodiments the support strip may be a support member and the support member may be a ring structure or a sheet whereby the plugs extend from varying locations along the periphery of the ring structure of sheet. For example, in one embodiment the support member may be a circular ring structure having an outer peripheral portion and the plugs may extend from the outer peripheral portion of the circular ring structure in a spaced apart manner. The other details of the plug apparatus 200 described herein may be incorporated into an embodiment wherein the support member is a ring structure or a sheet instead of an elongated strip.

In the exemplified embodiment, the distal end 212 of the support strip 210 is a free end of the support strip 210. Thus, in the exemplified embodiment there is nothing attached to or extending from the distal end 212 of the support strip 210. Furthermore, the plug apparatus 200 may comprise a grip member 220 that may be coupled to the proximal end 211 of the support strip 210. The grip member 220 may comprise a tab 221 having a first major surface 222 and a second major surface 223 opposite the first major surface 222. The first major surface 222 of the tab 221 of the grip member 220 may face in the same direction as the top-most surface 215 of the support strip 210 and the second major surface 223 of the tab 221 of the grip member 220 may face in the same direction as the bottom-most surface 216 of the support strip 210. The tab 221 may be a flat, rounded structure that protrudes from the proximal end 211 of the support strip 210 in the direction of the strip axis A-A. The round and flat shape of the tab 221 may make it easy for a user to grip the tab 221 between the thumb and forefinger of a single hand. However, the invention is not to be so limited and the tab 221 may take on other shapes, including simply being an extension of the support strip 221 without any plugs 100 extending therefrom, being square or other shaped, being spherical so that it can be gripped within a user's closed fist, or the like. In other embodiments, the grip member 220 may be omitted and the proximal end 211 of the support strip 210 may be a free end similar to the distal end 212 of the support strip 210.

As noted, the plug apparatus 200 may comprise a plurality of the plugs 100 that may be connected to the support strip 210 by the arms 250. The plurality of plugs 100 may comprise a first set of the plugs 110 that are located on and coupled to the first lateral side 213 of the support strip 210 and a second set of the plugs 120 that are located on and coupled to the second lateral side 214 of the support strip 210. As noted above, each of the plugs 100 of the first set of plugs 110 and each of the plugs 100 of the second set of plugs 120 may be coupled to the support strip 210 by one of the arms 250.

The first set of the plugs 110 may be arranged along the first lateral side 213 of the support strip 210 in a spaced apart manner. Adjacent ones of the plugs 100 of the first set of plugs 110 may be equidistantly spaced apart from one another. Specifically, each adjacent pair of the plugs 100 of the first set of plugs 110 may be spaced apart from one another by a first distance D1, with the first distance D1 being the same for each adjacent pair of the plugs 100 of the first set of plugs 110. In one embodiment, the first distance D1 may be in a range of 8 mm to 16 mm, more specifically 10 mm to 14 mm, more specifically 11 mm to 13 mm, and more specifically 11.5 mm to 12 mm.

The plugs 100 of the first set of plugs 110 may all extend the same distance from the first lateral side 213 of the support strip 210. That is, the plugs 100 of the first set of plugs 110 extend from the first lateral side 213 of the support strip 210 to a distal end 111. The distal ends 111 of each of the plugs 100 of the first set of plugs 110 may lie in the same plane.

The second set of the plugs 120 may be arranged along the second lateral side 214 of the support strip 210 in a spaced apart manner. Adjacent ones of the plugs 100 of the second set of plugs 120 may be equidistantly spaced apart from one another. Specifically, each adjacent pair of the plugs 100 of the second set of plugs 120 may be spaced apart from one another by a second distance D2, with the second distance D2 being the same for each adjacent pair of the plugs 100 of the second set of plugs 120. In one embodiment, the second distance D2 may be in a range of 8 mm to 16 mm, more specifically 10 mm to 14 mm, more specifically 11 mm to 13 mm, and more specifically 11.5 mm to 12 mm. In the exemplified embodiment, the second distance may be the same as the first distance. In other embodiments, the first and second distances may be different.

The plugs 100 of the second set of plugs 120 may all extend the same distance from the second lateral side 214 of the support strip 210. That is, the plugs 100 of the second set of plugs 120 extend from the second lateral side 214 of the support strip 210 to a distal end 121. The distal ends 121 of each of the plugs 100 of the second set of plugs 120 may lie in the same plane.

In the exemplified embodiment, the plugs 100 of the first set of plugs 110 are axially offset from the plugs 100 of the second set of plugs 120 in the direction of the strip axis A-A of the support strip 210. That is, each of the plugs 100 of the first set of plugs 110 is aligned with the space between an adjacent pair of the plugs 100 of the second set of plugs 120 and each of the plugs 100 of the second set of plugs 120 is aligned with the space between an adjacent pair of the plugs 100 of the first set of plugs 120. Stated another way, there is no axis transverse to the strip axis A-A that intersects one of the plugs 100 of the first set of plugs 110 and one of the plugs 120 of the second set of plugs 120. This may make it easier to disconnect one of the plugs 100 from the support strip 210 for insertion into one of the fastener holes without also disconnecting another one of the plugs 100. In other embodiments, the plugs 100 of the first set of plugs 110 may at least partially overlap or may fully overlap in the axial direction with the plugs 100 of the second set of plugs 120.

As noted above, each of the plugs 100 is connected to the support strip 210 by one of the arms 250. In alternative embodiments, multiple arms may be used to connect each of the plugs 100 to the support strip 210. In still other embodiments, the arms 250 may be omitted and the plugs 100 may be connected directly to the support strip 210. However, the arms 250 may be useful to allow for easy separation of one of the plugs 100 from the support strip 210 to fill in a fastener hole in a plank, as described further below. Each of the arms 250 may extend along an arm axis B-B. Each of the arm axes B-B may be oriented perpendicularly relative to the strip axis A-A. Thus, each of the arms 250 may extend along the arm axis B-B which extends transversely from the support strip 210. In other embodiments, the arm axis B-B may or oriented obliquely relative to the support axis A-A.

The arms 250 may have a width W2 and the plugs 100 may have a diameter D3. The width W2 and the diameter D3 may be measured in the direction of the strip axis A-A. The diameter D3 of the plugs 100 may be greater than the width W2 of the arms 250. In some embodiments, a ratio of the diameter D3 of the plugs 100 to the width W2 of the arms 250 may be between 3:1 and 6:1, and more specifically between 4:1 and 5:1. This may facilitate the breakage and separation of the plugs 100 from the arms 250 when driving the plugs 100 into the fastener hole, as described further below.

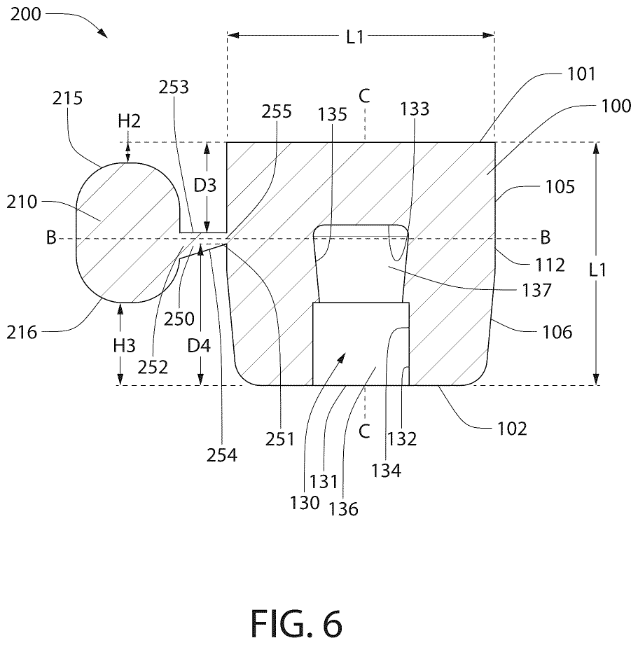

Referring now to FIG. 6, a cross-sectional view through one of the plugs 100, one of the arms 250, and the support strip 210 is provided. The plug 100 comprises a top surface 101 and a bottom surface 102. The plug 100 comprises a plug axis C-C that extends from the top surface 101 of the plug 100 to the bottom surface 102 of the plug 100. The plug axis C-C may be perpendicular to the strip axis A-A. The plug axis C-C may also be perpendicular to the arm axis B-B. The plug 100 (and each of the plugs 100) has a height H1 measured from the top surface 101 to the bottom surface 102 along the plug axis C-C. The plug 100 may have a circular transverse cross-sectional profile, to facilitate the fitting of the plug 100 into the fastener hole as described below. The height H1 of the plug(s) may be in a range of 3 mm to 9 mm, more specifically 4 mm to 8 mm, more specifically 5 mm to 7 mm, and more specifically 5.5 mm to 6 mm. The diameter D3 of the plug(s) 100 (which may be a maximum diameter of the circular transverse cross-sectional profile of the plug(s)) may be in a range of 4 mm to 11 mm, more specifically 5 mm to 8 mm, and more specifically 6 mm to 7 mm. In some embodiments, the diameter D3 of the plugs 100 may be greater than the height H1 of the plugs 100.

As noted previously, the support strip 210 comprises a top-most surface 215 and a bottom-most surface 216. The top surfaces 101 of the plugs 100 are located a second height (or distance) H2 above the top-most surface 215 of the support strip 210. The bottom surfaces 102 of the plugs 100 are located a third height (or distance) H3 below the bottom-most surface 216 of the support strip 210. In some embodiments, the third height H3 is greater than the second height H2. This allows a majority of the height H1 of the plugs 100 to extend below the bottom-most surface 216 of the support strip 210 so that a lower portion of the plug 100 can nest within the fastener hole prior to the plug 100 being separated from the support strip 210.

Each of the plugs 100 comprises an upper section 105 that comprises the top surface 101 and a lower section 106 that comprises the bottom surface 102. The upper section 105 may be cylindrical and the lower section 106 may be conical. The lower section 106 may be tapered moving in a direction from the upper section 105 to the bottom surface 102. That is, the diameter of the plug 100 may decrease along the lower section 106. The diameter of the plug 100 may continuously decrease along the lower section 106. This tapering of the lower section 106 allows the lower section 106 to more easily be inserted into a fastener hole in a plank. An impact device may then be used to apply a driving force onto the plug 100 to drive the plug 100 fully into the fastener hole, as described further below. The plug 100 may comprise an outer surface 112. The lower corner formed between the outer surface 112 and the bottom surface 102 may be rounded, which may further facilitate the insertion of the lower section 106 of the plug 100 into the fastener hole.

In the exemplified embodiment, each of the plugs 100 may comprise a central bore 130. The central bore 130 may extend from an opening 131 in the bottom surface 102 of the plug 100. The central bore 130 may extend along, and may be elongated along, the plug axis C-C. The central bore 130 may be a blind bore in that the central bore 130 may not extend fully through the plug 100 to the top surface 101. Rather, the central bore 130 may be defined by a sidewall 132 and a floor 133, such that the sidewall 132 extends from the bottom surface 102 to the floor 133. The floor 133 may form a terminus of the central bore 130. In other embodiments, the central bore 130 may be a through bore in that it may extend to from the opening 131 in the bottom surface 102 of the plug 100 to an opening in the top surface 101 of the plug 100.

The sidewall 132 of the central bore 130 may comprise a stepped inner wall surface comprising a lower sidewall portion 134 and an upper sidewall portion 135. The lower sidewall portion 134 may define a lower portion 136 of the central bore 130 having a continuous diameter. The upper sidewall portion 135 may define an upper portion 137 of the central bore 130 having a diameter that increases moving from the lower portion 136 to the floor 133. A downwardly facing shoulder 138 may be located at the transition between the lower and upper sidewall portions 134, 135. The downwardly facing shoulder 138 may face downwardly towards the bottom surface 102 of the plug 100. In other embodiments, the shape of the central bore 130 may be modified from that which is shown. For example, the central bore 130 may have a constant diameter along both of the lower and upper portions 136, 137, or the diameter of the central bore 130 may taper along both of the lower and upper portions 136, 137. Other modifications to the shape of the central bore 130 may be possible within the scope of the invention described herein. The central bore 130 may provide some flexibility to the lower section 106 of the plug 100 which may allow the lower portion 106 of the plug 100 to flex radially inwardly as the plug 100 is being inserted/driven into a fastener hole.

As noted above, each of the plugs 100 is coupled to the support strip 210 by an arm 250. In other embodiments, the plugs 100 may be coupled to the support strip 210 by a connection, which may be a direct connection between the plugs 100 and the support strip 210 or an indirect connection such as via the arm 250 or some other connecting structure. That is, in the exemplified embodiment the connection comprises the arm 250. In other embodiments, the connection may take on other forms.

In the exemplified embodiment, the plugs 100 are coupled to the support strip 210 via one of the arms 250 such that the arm 250 is connected to the plug 100 at a first connection 251 and to the support strip 210 at a second connection 252. The first connection 251 is located along the outer surface (or outer side surface) 112 of the plug 100. More specifically, the first connection 251 is located on the outer surface 112 of the plug 100 along the first (non-tapered) section 105 of the plug 100. Furthermore, the first connection 251 is spaced from the top surface 101 of the plug 100 by a distance D4 and from the bottom surface 102 of the plug 100 by a distance D5. In some embodiments, the distance D5 may be greater than the distance D4. This may further facilitate inserting a majority of the length of the plug 100 into the fastener hole before the first connection 251 abuts against the plank and prevents further insertion of the plug 100 prior to disconnecting the plug 100 from the arm 250.

The arm 250 has a transverse cross-sectional area that decreases moving in a direction along the arm axis B-B from the support strip 210 to the plug 100. The arm 250 comprises an upper surface 253 and a lower surface 254. The distance between the upper and lower surfaces 253, 254 may decrease moving from the support strip 210 to the plug 100. In an embodiment, the upper surface 253 is oriented horizontally and the lower surface 254 is angled upwardly moving from the support strip 210 to the plug 100. The upper surface 253 may be angled downwardly moving from the support strip 210 to the plug 100 in other embodiments. Due to the tapering of the arm 250 moving in a direction from the support strip 210 to the plug 100, the arm 250 is thinnest (measured between the upper and lower surfaces 253, 254) at the first connection 251 and thickest at the second connection 252. This allows the plug 100 to be readily disconnected from the arm 250 at the first connection 251 during insertion of the plugs 100 into the fastener hole.

The arms 250 may each comprise a fail section 255. The fail section 255 may be the section of the arm 250 which is configured to break to release the plug 100 from the support strip 210 during insertion of the plug 100 into the fastener hole of the plank. The fail section 255 may be the section of the arm 250 that is adjacent, or immediately adjacent, to the plug 100. The fail section 255 of the arm 250 may be the section of the arm 255 with the smallest transverse cross-sectional area of the arm 250. Thus, since the cross-sectional area of the arm 255 decreases moving from the support strip 210 towards the plug 100, the fail section 255 will be the section that is closest to the plug 100. The arm 250 is configured to shear at a position adjacent to the outer surface 112 of the plug 100 upon the plug 100 being inserted into the fastener hole, or during the insertion of the plug 100 into the fastener hole.

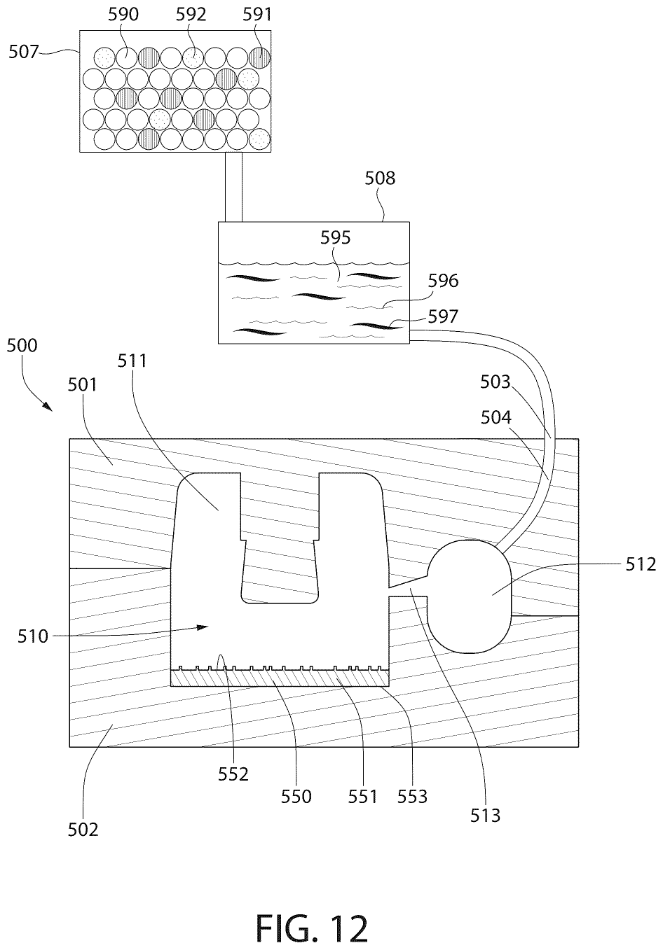

As will be discussed below with reference to FIGS. 12-15E, the plug apparatus 200 may be a monolithic injection molded component. That is, the plug apparatus 200 may be an integral, singular, unitary structure formed via an injection molding process or technique. So, the entire plug apparatus 200 may be formed as a singular unit in a mold cavity during an injection molding process. The plug apparatus 200 may be formed of a composition comprising a base polymeric material. The base polymeric material may be a hard plastic material. In an embodiment, the base polymeric material may be high density polyethylene. The composition may also comprise other materials, such as streaker materials, color additives, materials configured to protect against UV radiation, or the like.

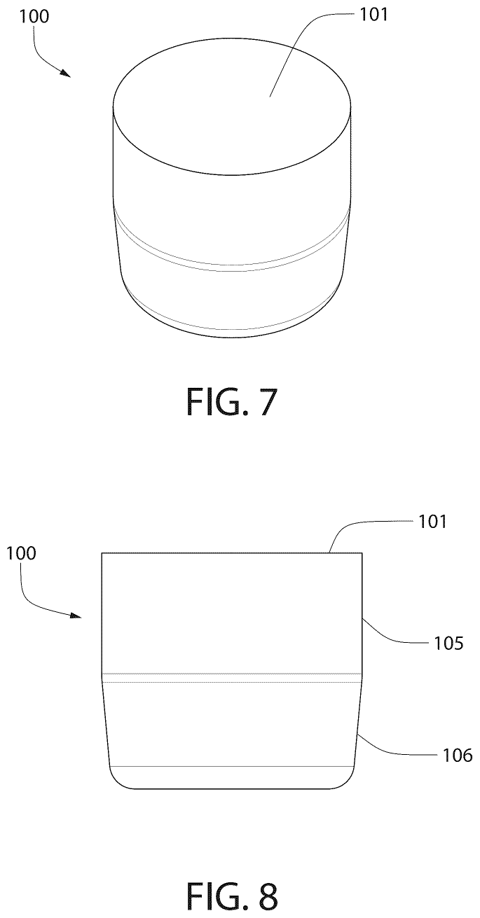

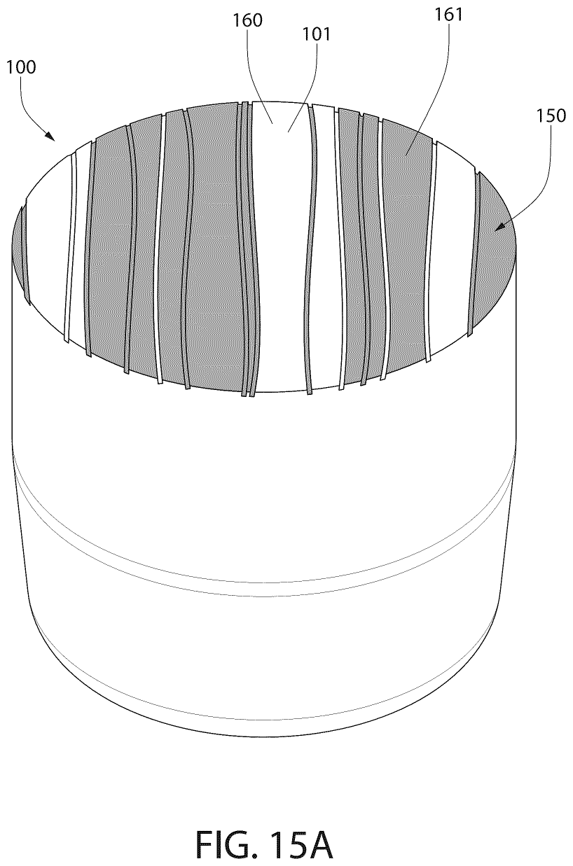

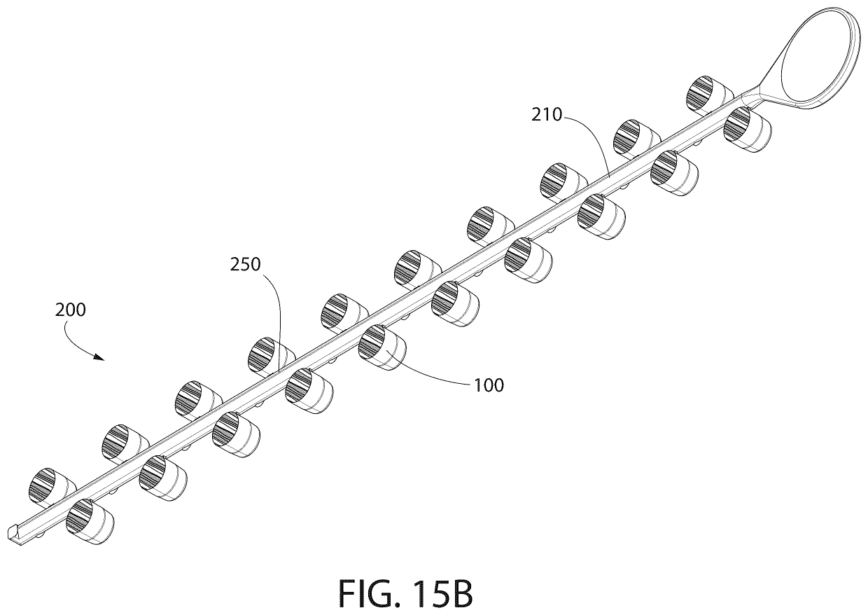

FIGS. 7 and 8 are views of one of the plugs 100 of the plug apparatus 200. Each of the plugs 100 is configured to conceal fastener holes formed in a plank. The plug 100 may be an injection molded monolithic body that is configured to be inserted into a fastener hole in a plank. As described further below, with specific reference to FIG. 15A, the injection molded monolithic body of the plug 100 may be formed of a composition comprising a polymeric base material and a streaker material. The top surface 101 of the plug 100 may have a texture feature comprising a debossed or embossed wood grain pattern, which is again shown in FIG. 15A and will be described in greater detail below. The purpose of such a texture feature may be to seamlessly transition between the planks and the plugs 100 when the planks are filling in fastener holes formed into the planks.

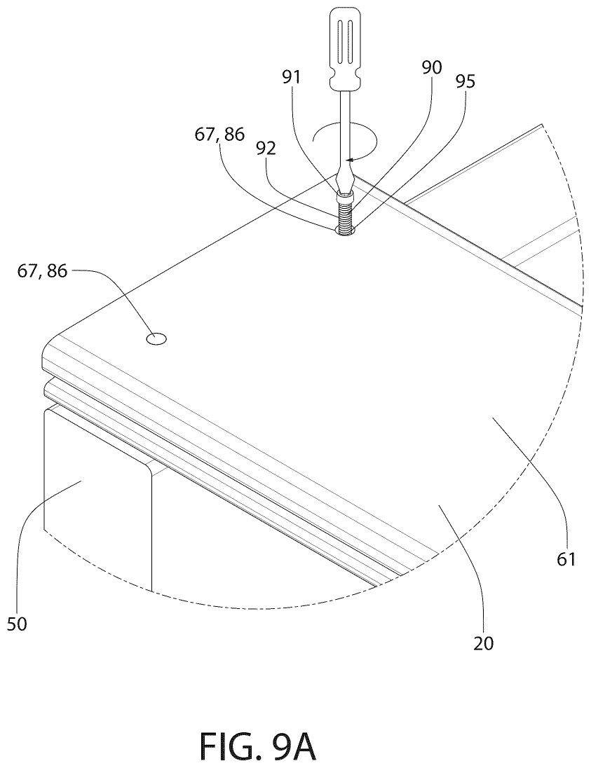

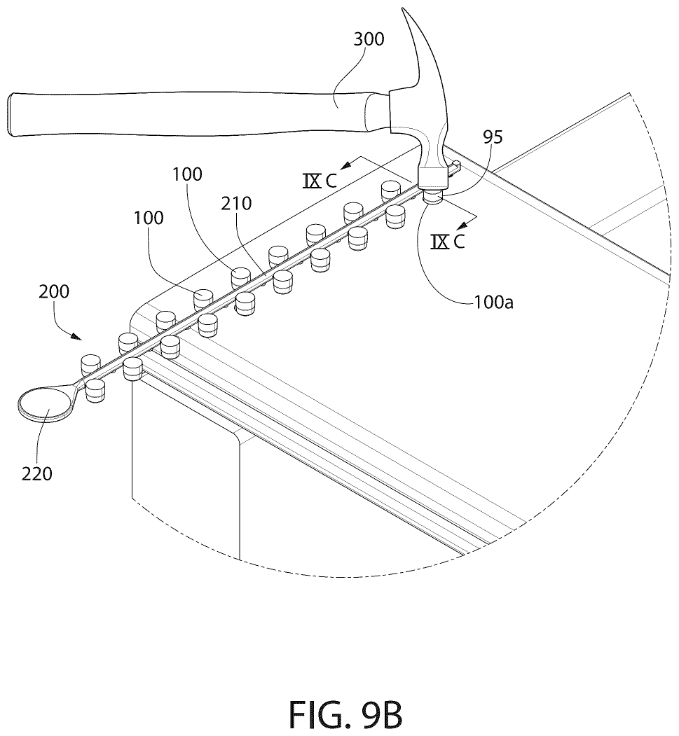

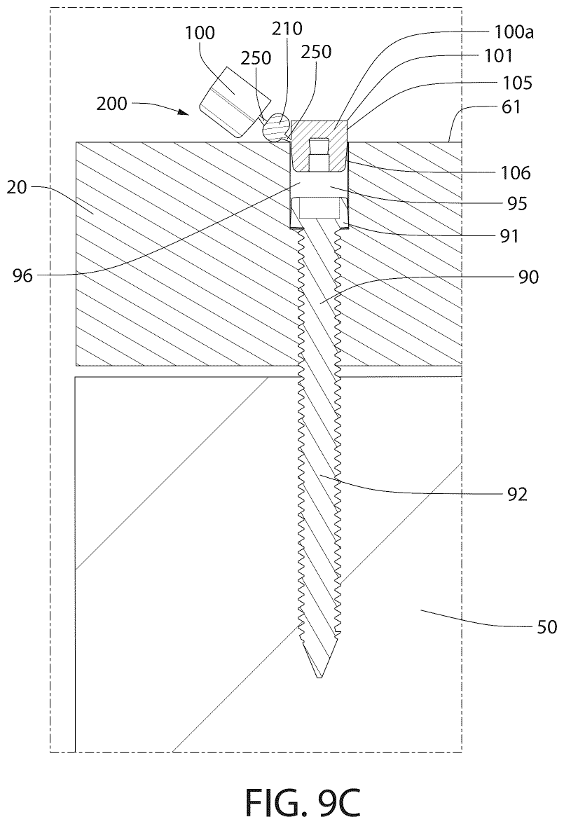

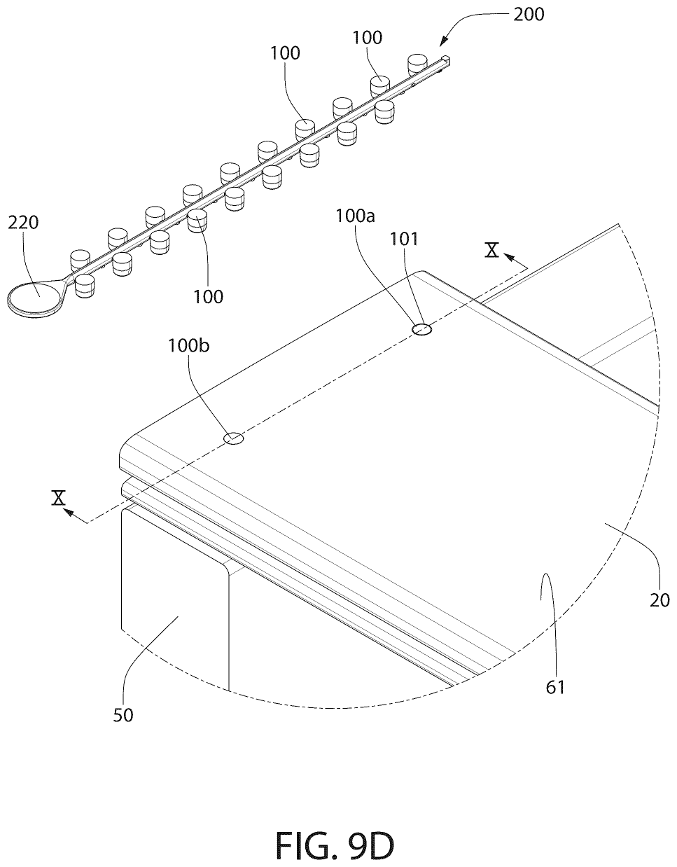

Referring to FIGS. 9A-D, a method of installing a decking system, such as the decking system 10 shown in FIG. 1, will be described. First, one of the planks 20 is positioned atop of one or more of the support structures 50 so that the plank 20 can be fastened to the support structure 50. Next, as shown in FIG. 9A, one of the fasteners 90 is inserted through each of the holes 67, 86 in the plank 20 and into the support structure 50 to fasten the plank 20 to the support structure 50. In the exemplified embodiment the fastener 90 is being driven into the plank 20 and the support structure 50 with a manual screwdriver, but a drill or other piece of equipment could be used in other embodiments depending on the type of fastener 90 used. Furthermore, in some embodiments the holes 67, 86 may not be pre-formed into the plank 20 and in such embodiments they may be drilled separately or formed by the act of driving the fastener 90 into the plank 20. The fastener 90 may have a head portion 91 and a post portion 92, and the post portion 92 may be threaded. When the fastener 90 is in its fully assembled state, the head portion 91 of the fastener 90 may be recessed below the top surface 61 of the plank 20. When the fastener 90 is inserted through the plank 20 and the support structure 50, a fastener hole 95 is formed.

Next, referring to FIGS. 9B and 9C, a first plug 100a of the plurality of plugs 100 of the plug apparatus 200 may be aligned with the fastener hole 95. This may be achieved by a user gripping the support strip 210 or the grip member 220 thereof and manipulating the support strip 210 and/or the grip member 220 so that the first plug 100a is aligned with the fastener hole 95. It is noted that the plank 20 is simplified in FIG. 9C and appears to be a monolithic structure, but the plank 20 may comprise a core and a shell as described above. The fastener 90 may be recessed below the top surface 61 of the plank 20 and as such there may be an empty space between the top of the head 91 of the fastener 90 and the top surface 61 of the plank 20. This empty space may form an upper portion 96 of the fastener hole 95. The first plug 100a may be pressed down at least partially into the fastener hole 95 within this empty space manually by the user a certain distance. Because the lower section 106 of the plug 100 is tapered, the lower section 106 of the plug 100 may be configured to be inserted into the fastener hole 95 fairly easily with manual user pressure for a certain distance. However, once the upper section 105 of the plug 100 starts to enter into the fastener hole 95, manual user pressure may be insufficient to continue driving the plug 100 into the fastener hole 95.

Furthermore, once the lower section 106 of the first plug 100a is positioned within the upper portion 96 of the fastener hole 95, the arm 250 that connects the first plug 100a to the support strip 210 may abut an edge of the plank 20 which surrounds the fastener hole 95. At this position the first plug 100a may be incapable of being inserted further into the fastener hole 95 without separating the first plug 100a from the arm 250.

Thus, once so positioned, an impact device 300 may be used to drive the first plug 100a further into the fastener hole 95. In the exemplified embodiment, the impact device 300 is a hammer, although other tools may be used to achieve the driving of the first plug 100a fully into the fastener hole 95. The spacing between the plugs 100 along the support strip 210 may provide for the ability to use a standard carpentry or framing hammer that allows the support strip 210 to be positioned over an installed screw 90 and the plug 100 then tapped into the fastener hole 95 with the hammer (or impact device 300) to drive the plug 100 flush to the decking surface. Due to the spacing between the plugs 100 (i.e., the first and second distances D1, D2), this may be accomplished without disturbing the other plugs 100 on the support strip 210.

The impact device 300 may be used to strike the top surface 101 of the first plug 100a to drive the first plug 100a fully into the fastener hole 95. The process of striking the top surface 101 of the first plug 100a with the impact device 300 may cause the arm 250 to break at its connection point to the first plug 100a. The breaking of the arm 250 may be further facilitated by the impact causing the edge of the plank 20 to pierce the arm 250 and weaken the arm 250 at its point of connection to the plug 100a. That is, the edge of the plank 20 may shear the connection between the arm 250 and the first plug 100a as the first plug 100a enters the fastener hole 95. Simply, the driving or inserting of the first plug 100a into the fastener hole 95 causes the first plug 100a to break off of and be released from the support strip 210.

The same process may then take place with a second one of the plugs 100 and a second one of the fastener holes. That is, the plug apparatus 200 may be manipulated so that a second one of the plugs 100 is aligned with a second one of the fastener holes. The second one of the plugs 100 may then be inserted into the fastener hole and then driven further into the fastener hole by an impact device. The action of driving the second one of the plugs 100 into the second one of the fastener holes may cause the second one of the plugs 100 to separate from the support strip 210 as described herein. The fail section 255 of the arms 250 as described above may break to release the plugs 100 from the support strips during the insertion of the plugs 100 into the fastener holes of the plank 20.

In an alternative embodiment, each of the plugs 100 may be formed as independent and distinct components, rather than being formed as part of the plug apparatus 200. In such an embodiment, in this step one of the plugs 100 may be aligned with the fastener hole 95 and driven into the hole. However, having the plugs 100 as separate and distinct components means that they will be loose and it may be difficult to keep track of them (i.e., they may easily get lost). Thus, in some embodiments it may be beneficial to have the plug apparatus 200 with the plurality of plugs 100 formed as a part of the plug apparatus 200.

Referring to FIGS. 9D, once the plugs, such as the first and second plugs 100a, 100b, are inserted into the various fastener holes, the plug apparatus 200 may be moved away from the plank 20. The plug apparatus 200 remains intact with the remaining plugs 100 which have not yet been separated from the support strip 210 all still forming part of the monolithic plug apparatus 200 component. The plug apparatus 200 may be moved along the deck surface to different locations therealong to plug different ones of the fastener holes with the plugs 100 of the plug apparatus 200 until all of the plugs 100 are separated from the support strip 210. In the exemplified embodiment, the plug apparatus 200 comprises twenty of the plugs 100, although the invention is not to be so limited and different numbers of the plugs 100 may be included by adjusting the length of the support strip 210, the shape of the support strip (or support member having a non-strip shape), etc. The grip apparatus 200 may have more or less than twenty plugs in other embodiments.

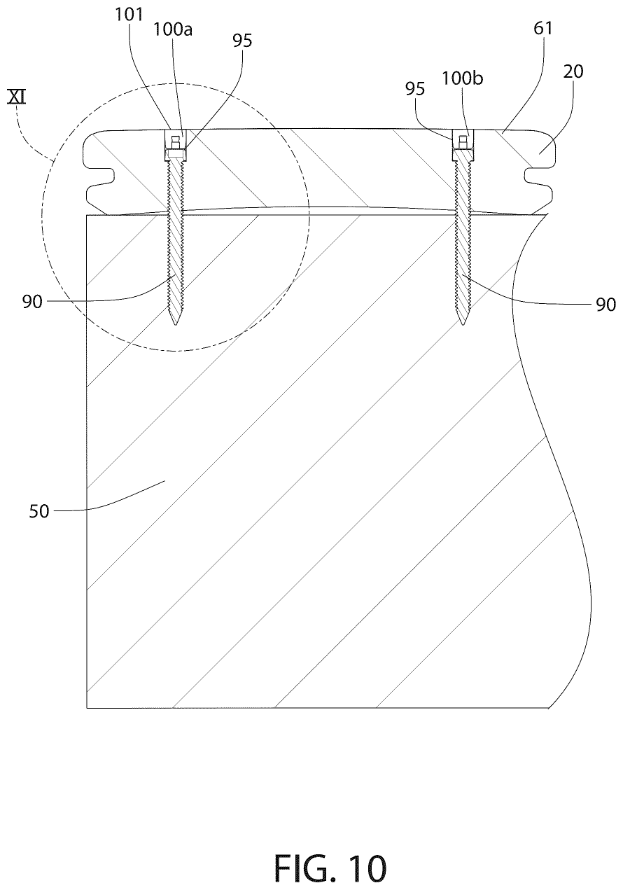

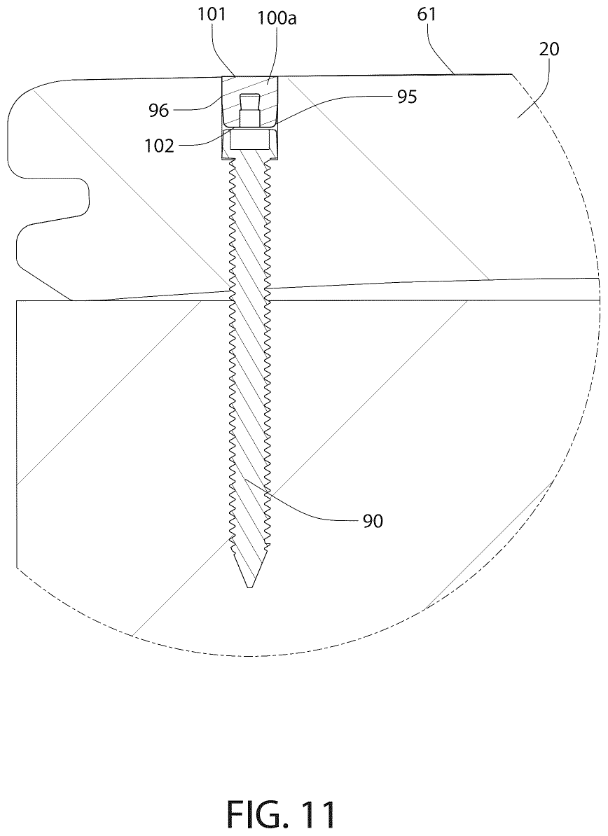

FIGS. 10 and 11 illustrate the deck assembly with the plank 20 coupled to the support structure 50 by one or more fasteners 90 and with the plugs 100 filling in the fastener holes 95 which remain between the top ends of the fasteners 90 and the top surface 61 of the planks 20. Once the first plug 100a is driven into the fastener hole 95 and separated from the plug apparatus 200, the first plug 100a nests within the upper portion 96 of the fastener hole 95 between the fastener 90 and the top surface 61 of the plank 20. The top surface 101 of the first plug 100a may be flush with the top surface 61 of the plank 20. Similarly, a second plug 100b may nest within another one of the fastener holes 95. The plug apparatus 200 may then be moved to another location where additional ones of the plugs 100 may be separated therefrom and inserted into additional fastener holes in the planks 20.

Referring to FIGS. 10 and 11, the relationship between the plugs 100, the fasteners 90, and the planks 20 will be further described. The plugs 100 may abut against the top ends of the fasteners 90, although this is not required in all embodiments. Specifically, in some embodiments when the plugs 100 are fully installed with the top surfaces 101 thereof flush with the top surface 61 of the planks 20, the bottom surfaces 102 of the plugs 100 may be spaced from the top end of the fasteners 90. The top surfaces 101 of the plugs 100 may be flush with the top surfaces 21 of the planks 20 to create a seamless appearance. Furthermore, as described herein, the textures, patterns, and colors of the top surfaces 21 of the planks 20 and the top surfaces 101 of the plugs 100 may match to further enhance the seamless aesthetic.

When the plugs 100 are fully inserted into the fastener holes 95, the plugs 100 have been fully separated from the arms 250 and the support strips 210. Furthermore, the arms 250 are attached to the plug 100 to provide enough strength to survive distribution and handling, while allowing easy separation of the plug 100 from the arm 250 during installation without leaving any of the arm 250 exposed at the surface of the deck. The plugs 100 may be held under radial compression from a wall of the fastener hole so that the plugs 100 are held tightly in place and are not readily removed from the fastener hole.

Referring to FIG. 12, a mold 500 comprising a mold cavity 510 that is configured to form the plug apparatus 200 is illustrated. The mold 500 comprises a first mold half 501 and a second mold half 502 that collectively define the mold cavity 510. The mold cavity 510 may comprise at least one plug chamber 511. The mold cavity 510 may also comprise at least one support member chamber 512 and at least one arm chamber 513, with the at least one arm chamber 513 extending between the at least one plug chamber 511 and the at least one support member chamber 512. In some embodiments, the mold cavity 510 may comprise only a plug chamber 511 to form one of the plugs 100. In other embodiments, the mold cavity 510 may comprise a plurality of the plug chambers 511, a plurality of the arm chambers 513, and the support member chamber 512 to form the plug apparatus 200 as a single, monolithic injection molded component.

In the exemplified embodiment, the first mold half 501 comprises an injection port 503 for the injection of one or more materials to form the plug apparatus 200 or portions thereof. The first mold part 501 may further comprise an injection passageway 504 that extends from the injection port 503 to the mold cavity 510. While the injection passageway 504 extends to the arm chamber 513 of the mold cavity 510 in the exemplified embodiment, the invention is not to be so limited and the injection passageway 504 may extend to any portion of the mold cavity 510.

Generally in an injection molding process, pellets formed from a plastic material are heated to melt the plastic which is then introduced or injected into the mold cavity. In the exemplified embodiment, there may be several different types/materials of pellets that are combined to form the plug apparatus. The various pellets that are melted to form the plug may be dry blended prior to being injected/introduced into the mold cavity. Thus, for example, a mixing container 507 may contain base resin pellets 590 formed from a high density polyethylene or HDPE material (to form the base polymeric material of the plug apparatus 200 as described above), color concentrate pellets 591 (to add color to the plug apparatus 200), and streaker pellets 592 (to form the streaks in the plug apparatus 200 to blend with the planks 20). Thus, the base resin pellets 590, the color concentrate pellets 591, and the streaker pellets 592 may be dry blended in the mixing container 507 at desired ratios/concentration levels (examples of which are provided below).

Next, the mixture of the base resin pellets 590, the color concentrate pellets 591, and the streaker pellets 592 may be fed to an injection molding extruder screw to melt the various pellets and blend them together. As the pellets 590, 591, 592 are melted, they may be converted from pellet form (which is a solid) to a liquid form, which allows the different materials of the different pellets 590, 591, 592 to mix and blend together, even if incompletely as described herein. In some embodiments, that melted blend may be immediately introduced into the mold cavity 510 from the molding extruder screw. However, for purposes of clarity and case of discussion, FIG. 12 illustrates the melted blend 595 held in a melt container 508 prior to being injected/introduced into the mold cavity 510 (again, in practice the melt container 508 may be omitted and the melted blend 595 may be formed by the molding extruder screw and immediately introduced into the mold cavity 510 without being stored or held in any container, or alternatively the melt container 508 may be a generic representation of such a molding extruder screw). Because the streaker pellets 592 are formed from a different polymer (e.g., polypropylene) than the base resin pellets 590 (e.g., HDPE), the streaker may melt and blend into the color and base resin incompletely. In an embodiment, the color pellets 591 and the base resin pellets 590 (when heated to a liquid form) may blend together completely, and the streaker pellets 592 (when heated to a liquid form) may blend incompletely with the color/base blend or may not blend at all with the color/base blend. As such, the melted blend 595 may include a base melt 596 having a first color and a streaker melt 597 having a second color that is visible within the base melt 596. The streaker melt 597 may not blend completely into the base melt 596, thereby leaving the streaker melt 597 visible in the melt blend 595 and also in the finished product (i.e. the plug apparatus 200) that is formed in the mold cavity 510. The melted blend 595 may form a fluidic composition that is injected into the mold cavity 510.

An insert 550 may be disposed within the plug chamber 511 of the mold cavity 510. The insert 550 may form a roof of the plug chamber 511. There may be one insert 550 positioned within each of the plug chambers 511 when the mold cavity 510 is configured for manufacture of the plug apparatus 200 comprising a plurality of the plugs 100.

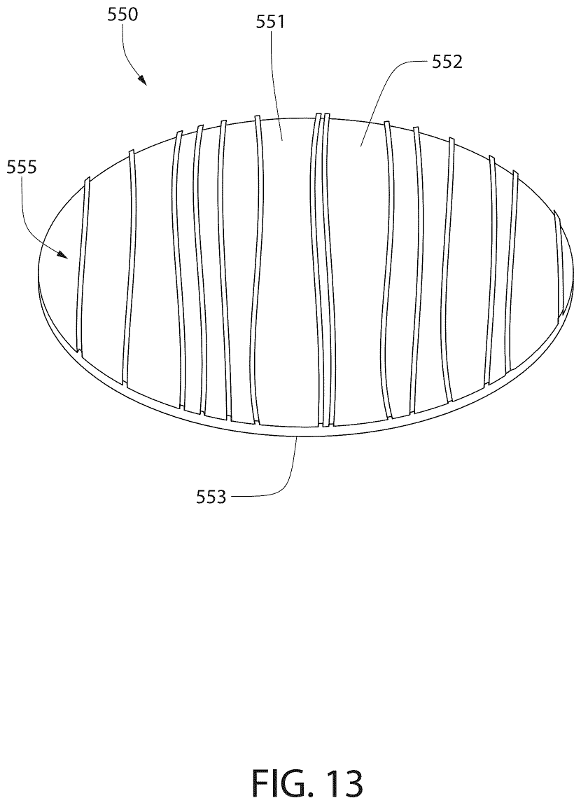

Referring to FIGS. 12 and 13, the insert 550 will be further described. The insert 550 comprises a plate body 551 having a first surface 552 and a second surface 553. The plate body 551 may be formed from a metal material. The first surface 552 may form a textured side of the plate body 551. The textured side of the plate body 551 may comprise a texture pattern 555. The texture pattern 555 of the textured side of the plate body 551 may be formed by an etching process. That is, the first surface 552 of the plate body 551 may be etched to define a specific texture pattern 555 therein. The texture pattern 555 may correspond to a texture pattern formed on a top outer surface of the planks 20 (such as the top surface 61 described above). The texture pattern may comprise embossed portions, debossed portions, or a combination of embossed and debossed portions. The insert 550 may be positioned within the plug chamber 511 of the mold cavity 510 so that the textured side formed by the first surface 552 of the plate body 551 forms a roof of the at least one plug chamber 511. As noted previously, where the mold cavity 510 comprises more than one plug chamber 511, a separate insert 550 may be positioned within each of the plug chambers 511.

The plate body 551 may be a thin plate on the order of 0.2-5 mm, or 0.2-3 mm, or 0.2-2 mm, or 0.5-2 mm in various different embodiments. The plate body 551 may be rigid in some embodiments and flexible in other embodiments. The plate body 551 may fit snug within a portion of the plug chamber 511 of the mold cavity 510 to form a texture pattern on the top surface of the plug that is formed in the plug chamber 511 of the mold cavity 510.

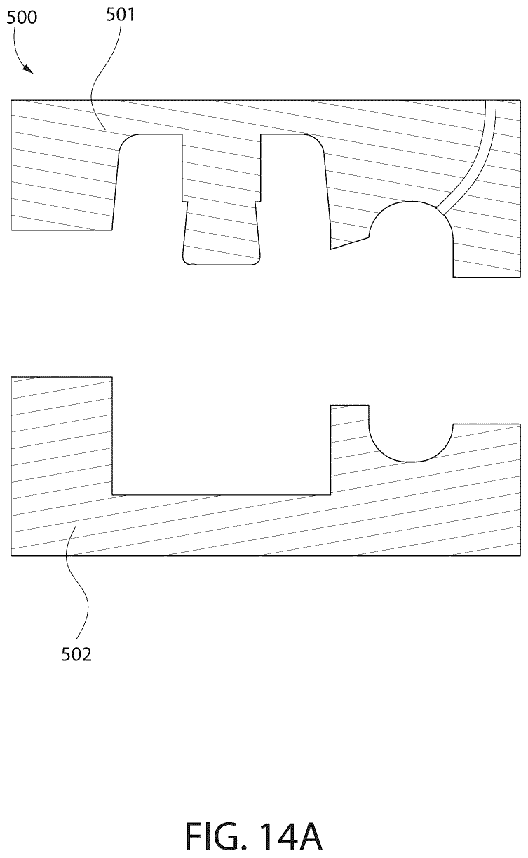

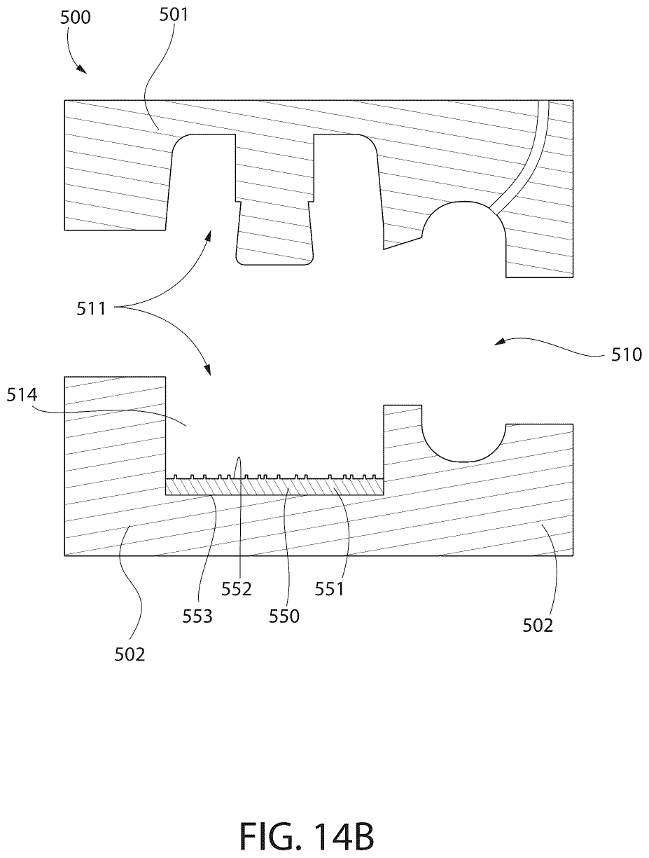

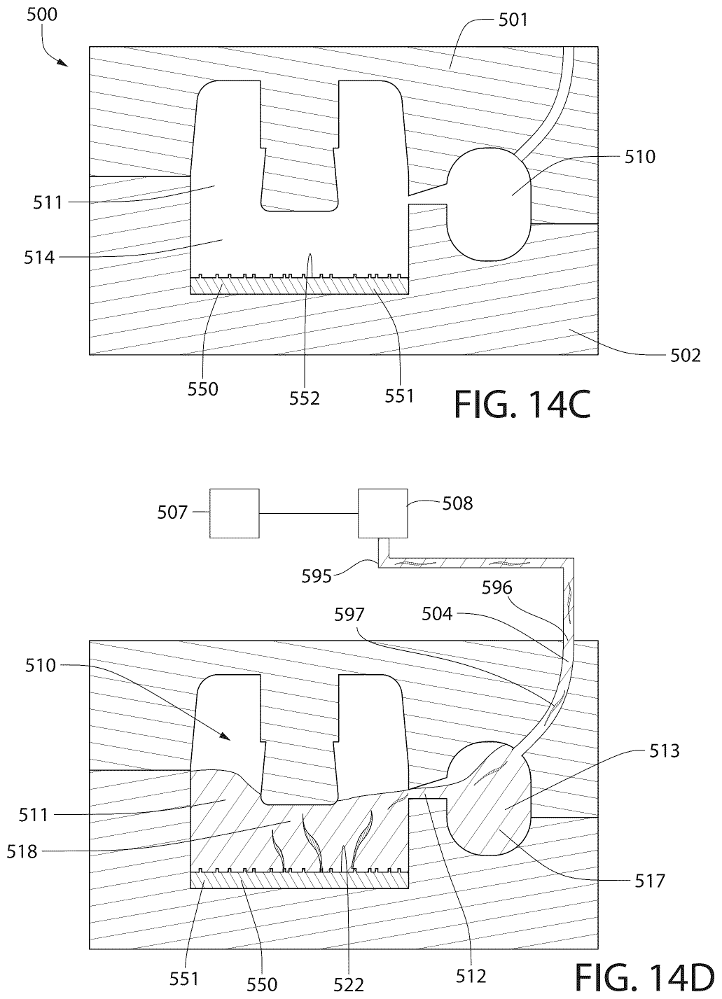

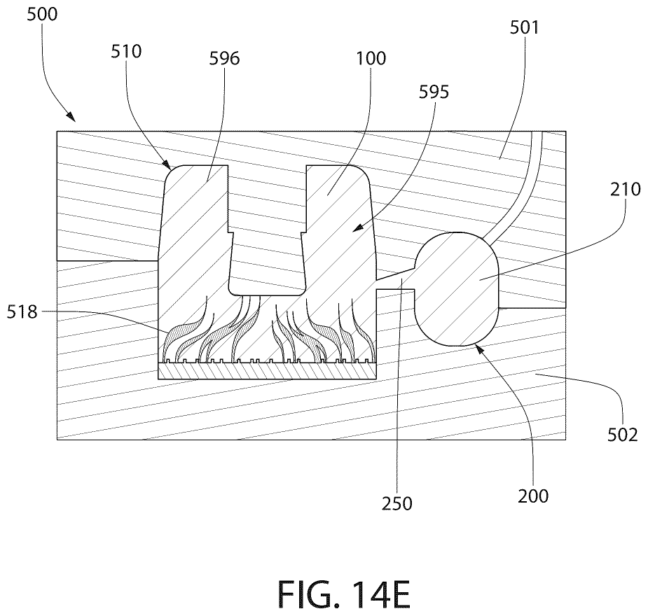

Referring to FIGS. 14A-14E sequentially, the method of manufacturing the plug apparatus 200 or the plugs 100 thereof will be described in accordance with an embodiment of the present invention. FIG. 14A illustrates the first and second mold parts 501, 502 of the mold 500 in an open state. In this state, the first and second mold parts 501, 502 are spaced apart from one another. The first and second mold parts 501, 502 may be placed into the open state in order to remove a formed plug apparatus 200 from the mold cavity 510 at the end of the manufacturing process. Each of the first and second mold parts 501, 502 may define a portion of the mold cavity 510.

Referring to FIG. 14B, with the first and second mold parts 501, 502 in the open state, one of the inserts 550 may be positioned into a portion 514 of the plug chamber 511 that is defined by the second mold part 502. In this embodiment, the portion 514 of the plug chamber 511 is where the upper section 105 of the plug 100 is formed. Thus, the first surface 552 of the plate body 551 of the insert 550 (i.e., the textured side) bounds the top surface 101 of the plug 100 as the plug 100 is formed inside of the mold cavity 510.

Referring to FIG. 14C, next the first and second mold parts 501, 502 are altered from the open state to a closed state. In the closed state, the ends of the first and second mold parts 501, 502 abut one another to define the mold cavity 510. The insert 550 remains located within the portion 514 of the plug chamber 511 that is defined by the second mold part 502.

Next, referring to FIG. 14D, the melted blend 595 which comprises the base melt 596 and the streaker melt 597 that has incompletely blended into the base melt 596 (and which collectively may form a fluidic composition) is injected into the injection passageway 504 to fill the mold cavity 510 with the melted blend 595. As mentioned above, the melted blend 595 may be injected directly from the mixing container 507, through an extruder screw, and into the mold cavity 510 rather than being held in the melt container 508 and injected from there into the mold cavity 510. The melted blend 595 may be injected into the mold cavity 510 in a heated or hot state such that the melted blend 595 is in a liquid phase at the time of injection into the mold cavity 510. Because the streaker melt 597 has incompletely blended into the base melt 596, the streaker melt 597 remains visible in the melted blend 595, and can therefore form streakers or visible streaks of material having a contrasting or different color than the base. Additional mixing of the base melt 596 and the streaker melt 597 may occur during the injection process as the material travels through the high-shear environment of the inner geometry of the mold, with the highest shear happening in the arm chamber 513.

Referring to FIG. 14E, once the mold cavity 510 has been filled with the melted blend 595, the melted blend 595 is allowed to cool. During the cooling, base melt 596 and the streaker melt 597 will harden into solid materials. Finally, the first and second mold parts 501, 502 may be altered back into the open state and the plug apparatus 200 (or the plug 100) may be removed from the mold cavity 510.

In an embodiment, the plug apparatus 200 may be formed from a composition. The composition may comprise a base polymeric material formed from the base HDPE resin pellets 590, a color material formed from the color concentrate pellets 591, and a streaker material formed from the streaker pellets 592. The base polymeric material may, in one embodiment, comprise high density polyethylene. Other polymeric materials may be used in other embodiments. In an embodiment, the base polymeric material may comprise high density polyethylene with ultraviolet protection. In an embodiment, the composition may further comprise color pigments. In an embodiment, the streaker material may comprise polypropylene. The streaker material may comprise polypropylene with color pigments. In an embodiment, the base melt 596 formed by melting the base HDPE resin pellets may comprise a first color and the streaker melt 597 formed by melting the streaker pellets 592 may comprise a second color. As such, the color of the streaker additive may be readily visible on the exterior of the plug apparatus 200 once formed.

In one embodiment, the high density polyethylene may comprise 88-97 wt % of the composition and/or of the finished plug 100. In one embodiment, color pigments may comprise 3-7 wt % of the composition and/or of the finished plug 100. In one embodiment, the polypropylene of the streaker additive may comprise 0.5-5 wt % of the composition and/or of the finished plug.

Referring to FIG. 15A, the plug 100 that is formed in the mold cavity 510 is illustrated in accordance with an embodiment of the present invention. The top surface 101 of the plug 100 comprises a texture feature 150. This is because the top surface 150 of the plug 100 is bounded by the front surface 552 of the plate body 551 of the insert 550 during manufacture. Thus, the texture pattern 555 of the insert 550 causes the formation of the texture feature 150 on the top surface 101 of the plug 100. Thus, the texture feature 150 may comprise a debossed feature, an embossed feature, or both. The texture feature 150 may comprise a debossed or embossed wood grain pattern. The texture pattern 150 on the top surface 101 of the plug 100 may be configured to match or correspond with a texture pattern on the top surface 61 of the planks 20 used in the decking system described herein.

The top surface 101 of the plug 100 may comprise a first portion 160 formed by the base melt 596 and a second portion 161 formed by the streaker melt 597. Because the base and streaker melts 596, 597 have different colors, the first and second portions 160, 161 of the top surface 101 of the plug 100 have different colors. This, once again, is intended to correspond with or match with a color pattern formed on the top surface 61 of the planks 20 of the decking system that the plugs 100 are configured to be used on.

FIG. 15B illustrates the plug apparatus 200 which may be formed in the mold cavity 510. That is, the mold cavity 510 may be sufficiently sized to form a plurality of the plugs 100, the arms 250, and the support strip 210 as a monolithic injection molded component. In other embodiments, the plugs 100 may be formed individually in the mold cavity 510 without the arms 250 and the support strip 210. In either case, the plugs 100 may have top surfaces 101 comprising: (1) the texture feature as described above; and (2) the dual-color due to the base polymeric material and the streaker additive being formed from different colors. The texture and dual-color may be designed to help the plugs 100 and the planks 20 have a seamless overall aesthetic when the plugs 100 are inserted into the fastener holes in the planks 20 as described above.

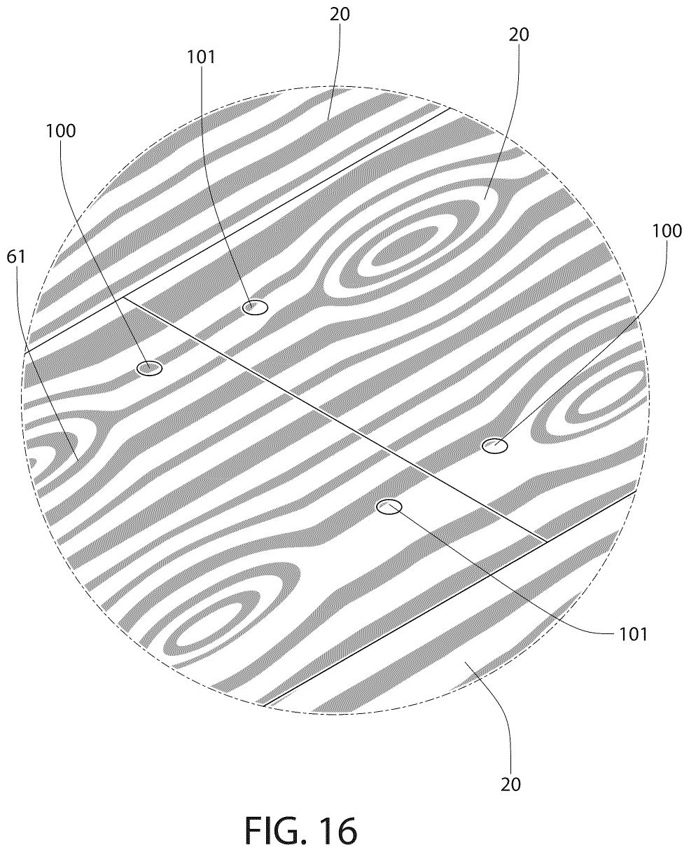

Referring to FIG. 16, a close-up view of a portion of the decking system 10 is illustrated in accordance with an embodiment of the present invention. The view of FIG. 16 is the same as FIG. 2, except that the texture patterns and dual-color is shown on the planks 20 and the on the plugs 100. The planks 20 comprise the top surface 61 formed of a composition having a first polymeric base material, as described. The plugs 100 are injection molded monolithic bodies that are configured to be inserted into and conceal fastener holes that are formed into the planks 20 when the fasteners/screws are used to fasten the planks 20 to the underlying support structure. The plugs 100 are formed from a second polymeric base material. The first and second polymeric base materials may be the same or they may be different. The first and second polymeric base materials may comprise polyethylene and may comprise high density polyethylene.

In an embodiment, the first and second polymeric base materials may be a first color. Furthermore, the composition of the top surface 61 of the plank 20 may comprise a first streaker material of a second color that is different from the first color. The composition of the top surface 101 of the plugs 100 may comprise a streaker material of the second color. Thus, each of the top surface 61 of the plank 20 and the top surface 101 of the plugs 100 may comprise a base material having a first color and a streaker material having a second color that is different than the first color. The top surface 61 of the plank 20 and the top surface 101 of the plugs 100 therefore have similar contrasting color schemes, which results in the formation of a consistent and continuous aesthetic appearance when the plugs 100 are inserted into the fastener holes of the planks 20.

In some embodiments, the top surface 61 of the plank 20 and the top surface 101 of the plugs 100 may comprise a debossed and/or embossed texture pattern. Thus, the top surface 101 of the plugs 100 may allow for a continuous texture aesthetic as the texture pattern on the top surface 101 of the plugs 100 is made to match the texture patter on the top surface 61 of the planks 20.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A plug apparatus for concealing fastener holes formed in planks, the plug apparatus comprising:
a support strip extending along a strip axis; and
a plurality of plugs connected to the support strip, each of the plugs configured to be inserted into a fastener hole in a plank, the plurality of plugs comprising:
a first set of the plugs located on a first lateral side of the support strip; and
a second set of the plugs located on a second lateral side of the support strip opposite the first lateral side.

2. The plug apparatus according to claim 1 wherein each of the plugs is connected to the support strip by an arm that projects from the support strip.

3. The plug apparatus according to claim 2 wherein each of the arms comprises a fail section configured to break and release the plug from the support strip upon the plug being inserted into the fastener hole of the plank.

4. The plug apparatus according to claim 3 wherein, for each of the arms, the fail section is adjacent the plug.

5. The plug apparatus according to claim 3 wherein, for each of the arms, the fail section comprises a smallest transverse cross-sectional area of the arm.

6. The plug apparatus according to claim 2 wherein each of the arms extends along an arm axis that extends transversely from the support strip.

7. The plug apparatus according to claim 1 wherein each of the plugs extends along a plug axis from a top surface of the plug to a bottom surface of the plug, and wherein each of the plugs comprises a central bore extending into the bottom surface along the plug axis.

8.-11. (canceled)

12. The plug apparatus according to claim 7 wherein, for each of the plugs, the top surface comprises a texture feature, wherein the texture feature comprises a debossed or embossed wood grain pattern.

13.-15. (canceled)

16. The plug apparatus according to claim 7 further comprising:
the support strip comprising a top-most surface and a bottom-most surface; and
the top surfaces of the plugs located a height above the top-most surface of the support strip and the bottom surfaces of the plugs located a height below the bottom-most surface of the support strip.

17. The plug apparatus according to claim 1 wherein the plug apparatus is a monolithic injection-molded component.

18. The plug apparatus according to claim 1 wherein the plug apparatus is formed of a composition comprising a base polymeric material, wherein the composition further comprises a streaker additive that is a different color than a color of the base polymeric material.

19. (canceled)

20. The plug apparatus according to claim 18 wherein the streaker additive comprises polypropylene.

21. The plug apparatus according to claim 18 wherein the base polymeric material comprises high-density polyethylene.

22. The plug apparatus according to claim 1 wherein the support strip extends along the strip axis from a proximal end to a distal end, further comprising a grip member connected to the proximal end of the support strip, the distal end of the support strip being a free end, wherein the grip member comprises a tab having a first major surface and a second major surface opposite the first major surface.

23. (canceled)

24. (canceled)

25. The plug apparatus according to claim 22 further comprising:
the first set of the plugs arranged along the first lateral side of the support strip in a spaced apart manner; and
the second set of the plugs arranged along the second lateral side of the support strip in a spaced apart manner;
wherein adjacent ones of the plugs of the first set are equi-spaced from one another by a first distance;
wherein adjacent ones of the plugs of the second set are equi-spaced from one another by a second distance, wherein the first distance is equal to the second distance; and
wherein the plugs of the first set are axially offset from the plugs of the second set along a length of the support strip.

26.-29. (canceled)

30. A plug apparatus for concealing fastener holes formed in planks, the plug apparatus comprising:
a support member; and
a plurality of plugs connected to the support member, each of the plurality of the plugs configured to be inserted into a fastener hole in a plank; and
wherein, for each of the plugs, a connection between the support member and the plug is configured to break to release the plug from the support member upon the plug being inserted into the fastener hole.

31. The plug apparatus according to claim 30 wherein each of the plugs extends along a plug axis from a top surface to a bottom surface; and wherein, for each of the plugs, the connection is located along an outer side surface of the plug, wherein, for each of the plugs, the connection is spaced from the top surface of the plug by a first distance, wherein, for each of the plugs, the connection is spaced from the bottom surface of the plug by a second distance, the second distance being greater than the first distance.

32. (canceled)

33. (canceled)

34. The plug apparatus according to claim 31 wherein each of the plugs comprises an upper section comprising the top surface and a tapered lower section comprising the bottom surface, the connection located along the upper section.

35. (canceled)

36. The plug apparatus according to claim 30 wherein, for each of the plugs, the connection comprises an arm protruding from the support member that spaces the plug from the support member, wherein, for each of the plugs, the arm comprises a fail section configured to break to release the plug from the support member, wherein the fail section has a smallest transverse cross-sectional area of the arm.

37.-60. (canceled)

61. A method of installing a decking system, the method comprising:
a) aligning a first plug with a first fastener hole formed in one or more planks, the first plug being one of a plurality of plugs connected to a support member, and
b) inserting the first plug into the first fastener hole, the first plug breaking off of and being released from the support member.

62.-70. (canceled)
